(19) United States
(12) Patent Application Publication
(10) Pub. No.: US 2007/0217495 A1
(43) Pub. Date: Sep. 20, 2007

(54) Apparatus and method for measuring SINR in mobile communication system using preambles

(75) Inventors: Ki-Young Han, Yongin-si (KR); Soon-Young Yoon, Seoul (KR); Keun-Chul Hwang, Segnam-si (KR); Sung-Soo Hwang, Suwon-si (KR); June Moon, Seoul (KR); Jong-In Kim, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/713,559

(22) Filed: Mar. 2, 2007

(30) Foreign Application Priority Data
Mar. 3, 2006 (KR) 2006-0020334

(51) Int. Cl. H04B 17/00; H04K 1/10

(52) U.S. Cl. 375/227; 375/260

(57) ABSTRACT

Apparatus and method for measuring an SINR in a mobile communication system using preambles. Calculated are an average noise power using a CP of an RX signal, a signal power of a serving segment, an average power of the serving segment, and an interference power of the serving segment, an average power of each interference segment, and an interference power of each interference segment using the difference between the calculated average noise power and the calculated average power. An SINR of the RX signal is calculated by dividing the calculated signal power of the serving segment by the sum of the calculated average noise power and the total interference power of all the segments.

### PRIORITY

This application claims priority under 35 U.S.C. § 119 to an application filed in the Korean Intellectual Property Office on Mar. 3, 2006 and allocated Serial No. 2006-20334, the contents of which are herein incorporated by reference.

### BACKGROUND OF THE INVENTION

1. Field of the Invention

The present invention relates generally to a mobile communication system, and more particularly, to an apparatus and method for measuring a Signal to Interference and Noise Ratio (SINR) in a mobile communication system using preambles.

2. Description of the Related Art

In addition to simple wireless communication services of the previous-generation mobile communication systems, the next-generation mobile communication systems aim at providing an integrated communication service and efficient interworking between a wired communication network and a wireless communication network. To this end, technologies are being standardized to provide higher-rate data transmission services in the previous-generation mobile communication systems.

When a signal is transmitted over a wireless channel in the mobile communication systems, the transmitted signal undergoes a multipath interference due to various obstacles existing between a transmitter and a receiver.

The wireless channel with the multipath is characterized by a maximum channel spread delay and a signal transmission period. When the signal transmission period is longer than the maximum channel spread delay, no interference occurs between consecutive signals and the channel has frequency-nonselective fading. However, when a single-carrier transmission scheme is used in high-rate data transmission with a short symbol period, inter-symbol interference becomes severe, which increases a distortion and the complexity of an equalizer in a receiver. An Orthogonal Frequency Division Multiplexing (OFDM) scheme has been proposed as an alternative for solving the equalizer problem of the single-carrier transmission scheme.

The OFDM scheme transmits data using a multicarrier. The OFDM scheme is a kind of multicarrier modulation scheme that converts a serial input symbol sequence into parallel signals and modulates the parallel signals with a plurality of orthogonal subcarriers (i.e., subcarrier channels) prior to transmission.

The OFDM scheme is efficient in frequency use because it uses a plurality of orthogonal subcarriers. In addition, the OFDM scheme is convenient for high-rate data processing because it uses a Fast Fourier Transform (FFT) scheme and an Inverse FFT (IFFT) scheme. Furthermore, the OFDM scheme is robust against multipath fading because it uses a Cyclic Prefix (CP). Moreover, the OFDM scheme is considered as a standard scheme for the fourth-generation mobile communication system and the next-generation communication systems because it is convenient for expansion into a Multiple-Input Multiple-Output (MIMO) system.

The OFDM system transmits a preamble every frame for the purposes of time/frequency synchronization, cell/sector ID acquisition, channel estimation, etc. The time synchronization (or frame synchronization) can be acquired by repeatedly transmitting, from a base station (BS), the preamble of the same pattern in a time domain and using the correlation of the repeated pattern at a mobile station (MS) that has received the preamble. Schemes of repeating the preamble of the same pattern in a time domain can be classified into a scheme of allocating the same data to a plurality of OFDM symbols and a scheme of allocating data every predetermined number of subcarriers in a frequency domain. The scheme of allocating the same data to a plurality of OFDM symbols increases overhead because the preamble is allocated to a plurality of OFDM symbols. Accordingly, if a scheme of allocating the preamble to one OFDM symbol can achieve the purpose of the preamble, the scheme of allocating data every predetermined number of subcarriers in a frequency domain can be regarded as being more efficient in terms of time resource efficiency.

FIGS. 1A, 1B and 1C are a diagram illustrating a method for allocating preambles in an Institute of Electrical and Electronics Engineers (IEEE) 802.16e system.

FIG. 1A illustrates a case where the first OFDM symbol is allocated a preamble and a preamble sequence of the same pattern is repeatedly allocated to every third subcarrier in a time domain. FIGS. 1B and 1C illustrate cases where a preamble sequence has the same amplitude as that of FIG. 1A but a repeated pattern is shifted. These three formats are called segments, and FIGS. 1A, 1B and 1C can be construed as being schematic preamble sequence structures corresponding respectively to segments 0, 1 and 2.

Assuming that the segment structure is identical to a general sector structure, one cell may have a total of three segments (i.e., a segment 0, a segment 1 and a segment 2) and preambles of the segments 0, 1 and 2 may be allocated respectively to sectors α, β and γ. An MS can easily detect a BS ID (identification) using the preamble.

An SINR measured at a receiver is fed back to a transmitter so that the transmitter uses a suitable Modulation and Coding Scheme (MCS) level. This can stabilize the link performance and also can enhance the system capacity by use of a high MCS level. In addition, the receiver measures SINRs of not only a serving BS but also other BSs, and can use the measured SINRs for determination of the need for handover. What is therefore required is accurate SINR measurement.

A conventional SINR estimation method includes correlating a predetermined reference sequence with RX signals of subcarriers allocated pilots in an OFDM symbol allocated with a pilot or a preamble; calculating interference/noise power using the difference between the correlation value for the subcarriers and a correlation value for one or more adjacent subcarriers; calculating a signal power by subtracting the calculated interference/noise power from the total signal power; and estimating an SINR by dividing the calculated signal power by the calculated interference/noise power. However, when preambles are employed for the SINR estimation method using the pilots, the SINR estimation performance is degraded.

FIG. 3 is a diagram illustrating an example of preamble signals. Herein, it is assumed that the preamble is allocated every predetermined number of subcarriers and each sector uses a preamble of different segment ID.

Referring to FIG. 3, a serving BS (or sector) uses a segment 0, and interference BSs (sectors) use segments 1 and 2. In this case, the power of the segments 0, 1 and 2 can be expressed as Equation (1):
P₀=Pₛ+I₀−P_{w}
P₁=I₁+P_{w}
P₂=I₂+P_{w} (1)

In Equation (1), Pᵢ denotes an average power of a subcarrier using the i^{th} segment, Pₛ denotes a signal power of the serving BS (or sector), Iᵢ denotes an average interference power of the subcarrier using the i^{th} segment, and P_{w} denotes an average noise power. Herein, it is assumed that the average noise power is identical in each segment.

The conventional mobile communication system estimates the SINR using Equation (2):

$$SINR = \frac{{P}_{s}}{{I}_{0} + {P}_{w}} \qquad ( 2 )$$

That is, the conventional mobile communication system measures the SINR only for subcarriers over which the serving BS (or sector) transmits signals. In general, I₁ and I₂ are very small and thus can be disregarded in the SINR estimation. However, I₁ and I₂ in a cell boundary area are large and thus cannot be disregarded in the SINR estimation. When I₁ and I₂ are large, the SINR is small and thus a handover is required. However, because the conventional mobile communication system disregards I₁ and I₂ as expressed in Equation (2), it estimates the SINR in the cell boundary area to be higher than an actual value. That is, the conventional mobile communication system may not perform a handover even in the cell boundary area, which may cause a call drop.

### SUMMARY OF THE INVENTION

An aspect of the present invention is to substantially solve at least the above problems and/or disadvantages and to provide at least the advantages below. Accordingly, an aspect of the present invention is to provide an apparatus and method for measuring an SINR in a mobile communication system using preambles.

According to one aspect of the present invention, a method for measuring an SINR in a mobile communication system using preambles includes calculating an average noise power using a CP (Cyclic Prefix) of an RX signal and calculating a signal power of a serving segment on the assumption that a frequency-domain channel is identical between adjacent subcarriers in the same segment; calculating an average power of the serving segment and calculating an interference power of the serving segment using the difference between the calculated average power and the sum of the calculated average noise power and the calculated signal power of the serving segment; calculating an average power of each interference segment and calculating an interference power of each interference segment using the difference between the calculated average noise power and the calculated average power; and calculating an SINR of the RX signal by dividing the calculated signal power of the serving segment by the sum of the calculated average noise power and the total interference power of all the segments.

According to another aspect of the present invention, an apparatus for measuring an SINR in a mobile communication system using preambles includes an ADC (Analog to Digital Converter) for converting an RX signal into a digital signal and outputting the time-domain digital signal to an SINR estimator; an FFT processor for transforming the CP-removed time-domain RX signal into a frequency-domain signal and outputting the frequency-domain signal to the SINR estimator; and the SINR estimator for calculating an average noise power using the time-domain digital signal received from the ADC, calculating a signal power of a serving segment using the RX frequency-domain signal received from the FFT processor, calculating an average power of the serving segment and an average power of each interference segment using a preamble signal of the RX frequency-domain signal received from the FFT processor, calculating an interference power of the serving segment and an interference power of the interference segment using the calculated average noise power, the calculated signal power of the serving segment, the calculated average power of the serving segment, and the calculated average power of the interference segment, and estimating an SINR using the calculated average noise power, the calculated signal power and interference power of the serving segment, and the calculated interference power of the interference segment.

### BRIEF DESCRIPTION OF THE DRAWINGS

The above and other aspects, features and advantages of the present invention will become more apparent from the following detailed description when taken in conjunction with the accompanying drawings in which:

FIGS. 1A, 1B and 1C are a diagram illustrating a method for allocating preambles in an IEEE 802.16e system;

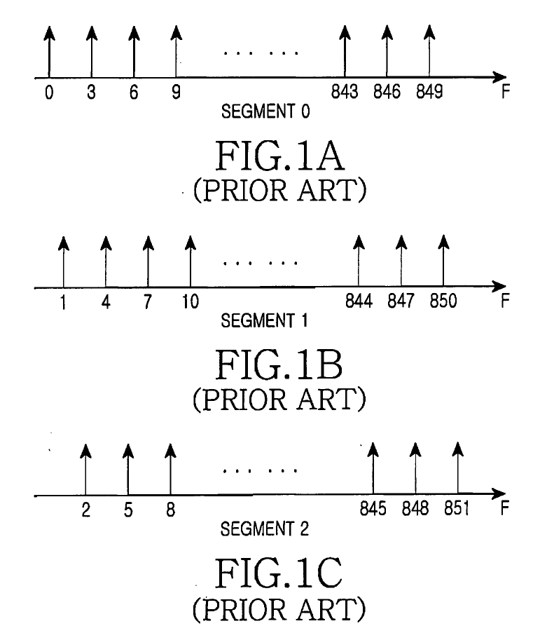

FIG. 2 is a diagram illustrating an example of a segment structure;

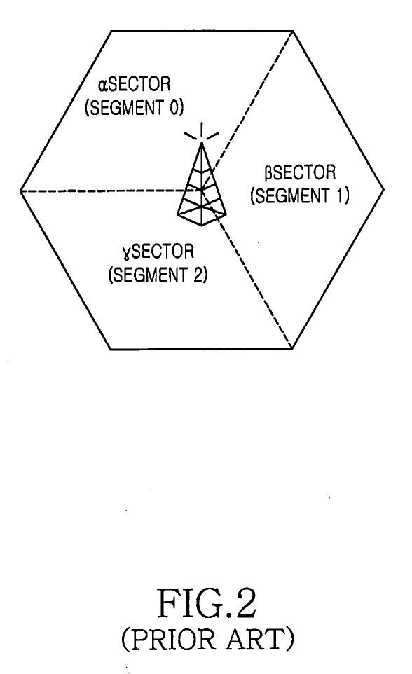

FIG. 3 is a diagram illustrating an example of preamble signals;

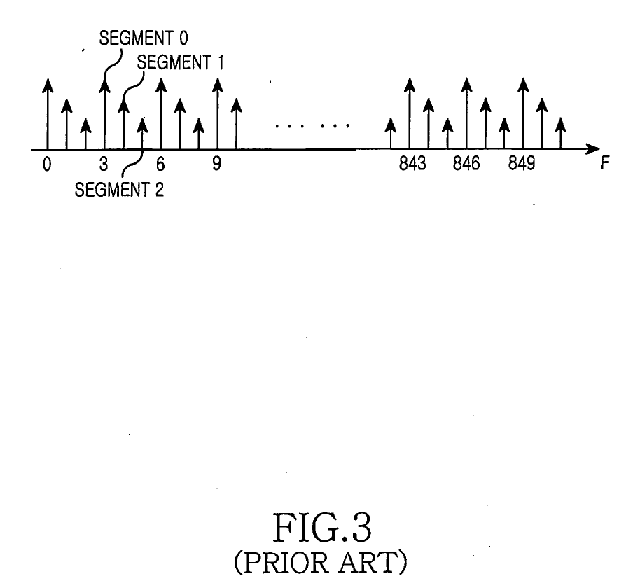

FIG. 4 is a block diagram of a receiver in a mobile communication system according to the present invention;

FIG. 5 is a block diagram of an SINR estimator in a mobile communication system using preambles according to the present invention; and

FIG. 6 is a flowchart illustrating a procedure for measuring an SINR in a mobile communication system using preambles according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail for clarity and conciseness.

The present invention provides an apparatus and method for measuring an SINR in a mobile communication system using preambles. The following description will be given using an OFDM system in which a preamble sequence is allocated every three subcarriers at one OFDM symbol in a frequency domain and different segment IDs are used by three neighboring BSs to construct a preamble, as an example of the mobile communication system.

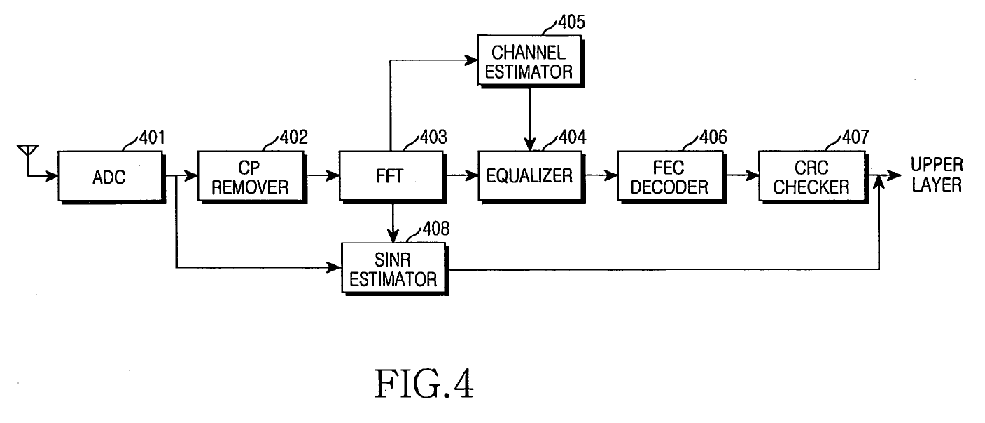

FIG. 4 is a block diagram of a receiver in a mobile communication system according to the present invention.

Referring to FIG. 4, the receiver includes an analog-to-digital converter (ADC) 401, a CP remover 402, an FFT processor 403, an SINR estimator 408, a channel estimator 405, an equalizer 404, a channel decoder 406, and an error detector 407.

The ADC 401 converts an RX signal, received from an RX antenna, into a digital signal and outputs the digital signal to the CP remover 402 and the SINR estimator 408.

The CP remover 402 removes a CP, inserted by a transmitter for robustness against a multipath channel, from the digital signal and outputs the CP-removed time-domain signal to the FFT processor 403.

The FFT processor 403 transforms the CP-removed time-domain signal into a frequency-domain signal and outputs the frequency-domain signal to the equalizer 404 and the SINR estimator 408. In addition, the FFT processor 403 outputs a preamble signal of the frequency-domain signal to the channel estimator 405.

The SINR estimator 408 calculates an average noise power using the time-domain digital signal received from the ADC 401, calculates a signal power of a serving segment using the frequency-domain signal received from the FFT processor 403, calculates an average power of the serving segment and an average power of each interference segment using the preamble signal of the frequency-domain signal received from the FFT processor 403, calculates an interference power of the serving segment and an interference power of the interference segment using the calculated average noise power, the calculated signal power of the serving segment, the calculated average power of the serving segment, and the calculated average power of the interference segment, and estimates an SINR using the calculated average noise power, the calculated signal power and interference power of the serving segment, and the calculated interference power of the interference segment. The SINR estimator 408 outputs the estimated SINR to an upper layer (i.e., a Medium Access Control (MAC) layer).

The channel estimator 405 estimates a channel using the preamble signal received from the FFT processor 403 and outputs the estimated channel to the equalizer 404.

Using the frequency-domain signal received from the FFT processor 403 and the estimated channel received from the channel estimator 405, the equalizer 404 removes a multipath noise of an RX frequency-domain signal (i.e., corrects a distortion caused by interference and channel instability during transmission of the RX signal over a radio channel), calculates a Log Likelihood Ratio (LLR), and outputs the LLR to the channel decoder 406.

For example, the channel decoder 406 may be implemented using a Forward Error Correction (FEC) decoder. Using the LLR received from the equalizer 404, the channel decoder 406 decodes encoded data into encoded binary data (i.e., decodes encoded data into information data using a decoding scheme corresponding to a coding scheme used by a transmitter), and outputs the information data to the error detector 407.

For example, the error detector 407 may be implemented using a Cyclic Redundancy Check (CRC) checker. The error detector 407 detects a possible error in the information data received from the channel decoder 406. When there is no error in the information data, the error detector 407 transmits the information data to the MAC layer.

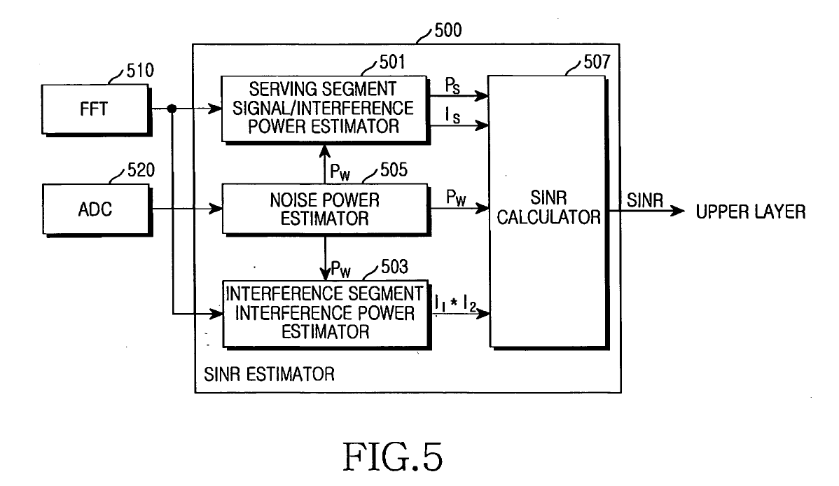

FIG. 5 is a block diagram of an SINR estimator in a mobile communication system using preambles according to the present invention.

Referring to FIG. 5, an SINR estimator 500 includes a serving segment signal/interference power estimator 501, an interference segment interference power estimator 503, a noise power estimator 505, and an SINR calculator 507.

The noise power estimator 505 estimates an average noise power using a CP of an RX time-domain signal received from an ADC 520, and outputs the estimated average noise power to the serving segment signal/interference power estimator 501, the interference segment interference power estimator 503 and the SINR calculator 507. An FFT processor 510 outputs an RX frequency-domain signal of each of subcarriers, which are allocated a preamble sequence, to the serving segment signal/interference power estimator 501 and the interference segment interference power estimator 503.

The serving segment signal/interference power estimator 501 correlates the RX frequency-domain signal received from the FFT processor 510 with a conjugate complex of a predetermined preamble sequence, calculates a correlation value AₖAₖ₊₁ of a correlation value Aₖ of a predetermined subcarrier and a correlation value Aₖ₊₁ of an adjacent subcarrier in the same segment, estimates a signal power of a serving segment using the calculated correlation value, and outputs the estimated signal power of the serving segment to the SINR calculator 507.

In addition, the serving segment signal/interference power estimator 501 calculates an average power of the serving segment using the RX frequency-domain preamble signal received from the FFT processor 510, estimates an interference power of the serving segment at a value obtained by subtracting the estimated average noise power and the estimated signal power of the serving segment from the calculated average power of the serving segment, and outputs the estimated interference power of the serving segment to the SINR calculator 507.

The interference segment interference power estimator 503 calculates an average power of each interference segment using the RX frequency-domain preamble signal received from the FFT processor 510, estimates an interference power of the interference segment at a value obtained by subtracting the estimated average noise power from the calculated average power of the interference segment, and outputs the sum of the estimated interference powers of all the interference segments to the SINR calculator 507.

The SINR calculator 507 calculates an SINR by dividing the estimated signal power of the serving segment by the sum of the estimated average noise power, the estimated interference power of the serving segment and the estimated interference powers of the interference segments, and transmits the calculated SINR to an upper layer.

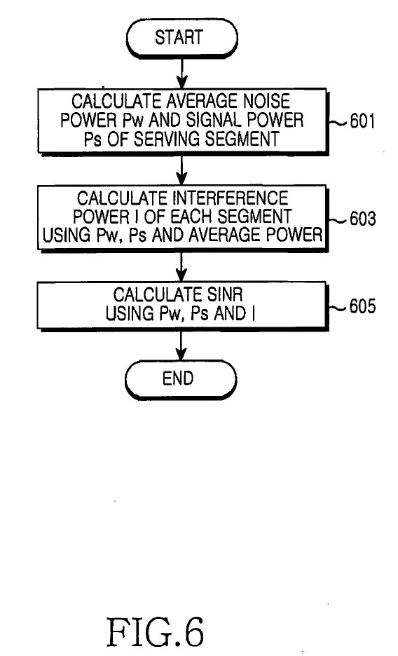

FIG. 6 is a flowchart illustrating a procedure for measuring an SINR in a mobile communication system using preambles according to the present invention.

When a serving BS (or sector) uses a segment 0, a signal received over a subcarrier corresponding to each segment can be expressed as Equation (3):
Y_{0,k}=H_{0,k}X_{0,k}+Z_{0,k}+W_{0,k}
Y_{1,k}=Z_{1,k}+W_{1,k}
Y_{2,k}=Z_{2,k}+W_{2,k} (3)

In Equation (3), Y_{i,k} denotes a signal received over the k^{th} subcarrier of the i^{th} segment, and X_{0,k} denotes a preamble sequence transmitted from a serving BS (or sector) over the k^{th} subcarrier of the 0^{th} segment. The serving BS (or sector) modulates the preamble sequence in a predetermined scheme (e.g., a binary phase shift keying (BPSK) scheme) and boosts the modulated preamble sequence prior to transmission to a receiver, thereby maximizing the preamble sequence detection probability at the receiver. H_{0,k} denotes channel characteristics experienced by the preamble sequence transmitted from the serving BS (or sector) over the k^{th} subcarrier of the 0^{th} segment, Z_{i,k} denotes an interference at the k^{th} subcarrier of the i^{th} segment, and W_{i,k} denotes a noise at the k^{th} subcarrier of the i^{th} segment. X_{0,k} is a predetermined preamble sequence and thus its value is foreknown by the receiver. Y_{i,k} is obtained by measurement.

Referring to FIG. 6, in step 601, the SINR estimator 500 calculates an average noise power using a CP of an RX time-domain signal, and calculates a signal power of the serving segment on the assumption that a frequency-domain channel is identical between adjacent subcarriers in the same segment.

A description will first be given of a process for calculation of the average noise power. For use of a simple equalizer for a multipath channel, the OFDM system copies a predetermined number of suffix samples of an OFDM symbol and prefixes the copied suffix samples to the OFDM symbol, which is the CP. An OFDM symbol containing each CP has the same repeated portion, and an average noise power can be calculated using the repeated portion.

The average noise power P_{w} can be calculated using Equation (4):

$${P}_{w} = \frac{1}{2 NM} {\sum }_{n = 0}^{N - 1} {\sum }_{m = 0}^{M - 1} {\vert y ( m , n ) - y ( m , n + {N}_{FFT} ) \vert}^{2} \qquad ( 4 )$$

In Equation (4), y(m,n) denotes the n^{th} sample of the m^{th} OFDM symbol, and N_{FFT} denotes an FFT size used in the OFDM system. That is, y(m,n) corresponds to a repeated portion of y(m,n+N_{FFT}). M denotes the number of OFDM symbols used for noise power estimation, and N denotes the number of samples in a CP duration used in one OFDM symbol. Because a portion of the CP duration may be contaminated by a multipath noise, N is set to be smaller than the CP duration sample number.

A description will now be given of a process for calculation of the signal power of the serving segment. The SINR estimator 500 correlates a frequency-domain signal, received over a subcarrier allocated to the serving segment, with a conjugate complex of a predetermined preamble sequence, and correlates a correlation value for the subcarrier with a correlation value for an adjacent subcarrier in the same segment to calculate the signal power of the serving segment.

The signal power Pₛ of the serving segment can be calculated using Equation (5):

$${P}_{s} = \frac{1}{{N}_{s} - 1} Re \{ {\sum }_{k = 0}^{{N}_{s} - 2} {Y}_{0 , k} {X}_{0 , k}^{*} {Y}_{0 , k + 1}^{*} {X}_{0 , k + 1} \} \qquad ( 5 )$$

In Equation (5), Nₛ denotes the number of preamble sequences allocated to the serving segment, i.e., the number of subcarriers allocated a preamble sequence, a superscript * denotes a conjugate complex. The preamble sequence uses a Binary Phase Shift Keying (BPSK) scheme and has a boosted size. When the size of the preamble sequence X_{0,k} is not 1, Equation (5) is divided by the size B of the corresponding preamble sequence as Equation (6):

$${P}_{s} = \frac{1}{B ( {N}_{s} - 1 )} Re \{ {\sum }_{k = 0}^{{N}_{s} - 2} {Y}_{0 , k} {X}_{0 , k}^{*} {Y}_{0 , k + 1}^{*} {X}_{0 , k + 1} \} \qquad ( 6 )$$

In step 603, the SINR estimator 500 calculates an interference power I of each segment using the average noise power P_{w}, the signal power Pₛ of the serving segment, an average power of the serving segment, and an average power of the interference segment. The average power of the serving segment and the average of the interference segment can be calculated using the RX frequency-domain preamble signal. The interference power of each segment can be calculated by subtracting a partial power from the total average power.

An interference power I₀ of the serving segment can be calculated using Equation (7):

$${I}_{0} = \frac{1}{{N}_{s}} {\sum }_{k = 0}^{{N}_{s} - 1} {\vert {Y}_{0 , k} \vert}^{2} - {P}_{s} - {P}_{w} \qquad ( 7 )$$

That is, the interference power I₀ of the serving segment equals the difference between the average power and the sum of the average noise power P_{w} and the signal power Pₛ of the serving segment.

An interference power I of an interference segment can be calculated using Equation (8):

$${I}_{1} + {I}_{2} = \frac{1}{{N}_{1}} {\sum }_{k = 0}^{{N}_{1} - 1} {\vert {Y}_{1 , k} \vert}^{2} + \frac{1}{{N}_{2}} {\sum }_{k = 0}^{{N}_{2} - 1} {\vert {Y}_{2 , k} \vert}^{2} - 2 {P}_{w} \qquad ( 8 )$$

In Equation (8), N₁ denotes the number of subcarriers allocated to the i^{th} segment. An interference power of each interference segment equals the difference between the average power of the interference segment and the average noise power P_{w}.

In step 605, the SINR estimator 500 calculates an SINR using the average noise power P_{w}, the signal power Pₛ of the serving segment, and the interference power I of each segment. That is, the SINR can be calculated by dividing the signal power of the serving segment by the sum of the average noise power and the total interference power.

The SINR can be expressed as Equation (9):

$$SINR = \frac{{P}_{S}}{{I}_{0} + {I}_{1} + {I}_{2} + {P}_{w}} \qquad ( 9 )$$

In Equation (9), the numerator equals the RX signal power of the serving segment, excluding an interference and an noise, and the denominator equals the sum of the interference/noise signal powers of the serving segment and the interference segments.

Thereafter, the SINR estimator 500 ends the procedure.

As described above, the present invention provides the apparatus and method for measuring an SINR in a mobile communication system using preambles. In general, the preambles have a higher density than pilots. That is, a frequency bandwidth between subcarriers allocated a preamble sequence or adjacent pilots is small. Accordingly, the present invention can provide more accurate SINR estimation in environments with severe frequency-selective fading.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for measuring a signal to interference and noise ratio (SINR) in a mobile communication system using preambles, comprising:
calculating an average noise power using a cyclic prefix (CP) of a receiving (RX) signal and calculating a signal power of a serving segment on an assumption that a frequency-domain channel is identical between adjacent subcarriers in a same segment;
calculating an average power of the serving segment, and calculating an interference power of the serving segment using the difference between the calculated average power and the sum of the calculated average noise power and the calculated signal power of the serving segment;
calculating an average power of each interference segment, and calculating an interference power of each interference segment using the difference between the calculated average noise power and the calculated average power; and
calculating an SINR of the RX signal by dividing the calculated signal power of the serving segment by the sum of the calculated average noise power and the total interference power of all the segments.

2. The method of claim 1, wherein the average noise power is calculated using:
$${P}_{w} = \frac{1}{2 NM} {\sum }_{n = 0}^{N - 1} {\sum }_{m = 0}^{M - 1} {\vert y ( m , n ) - y ( m , n + {N}_{FFT} ) \vert}^{2}$$
where y(m, n) denotes the n^{th} sample of the m^{th} symbol, N_{FFT} denotes an FFT size, M denotes the number of symbols used for noise power estimation, and N denotes the number of samples in a CP duration used in one symbol.

3. The method of claim 1, wherein the signal power of the serving segment is calculated using:
$${P}_{s} = \frac{1}{B ( {N}_{s} - 1 )} Re \{ {\sum }_{k = 0}^{{N}_{s} - 2} {Y}_{0 , k} {X}_{0 , k}^{*} {Y}_{0 , k + 1}^{*} {X}_{0 , k + 1} \}$$
where Nₛ denotes the number of preamble sequences allocated to the serving segment, i.e., the number of subcarriers allocated a preamble sequence, Y_{0,k} denotes a signal received over the k^{th} subcarrier of the serving segment, X_{0,k} denotes a preamble sequence transmitted from a serving base station over the k^{th} subcarrier of the serving segment, a superscript * denotes a conjugate complex, and B denotes the size of the preamble sequence X_{0,k}.

4. The method of claim 1, wherein the interference power of the serving segment is calculated using:
$${I}_{0} = \frac{1}{{N}_{s}} {\sum }_{{N}_{s}}^{{N}_{s} - 1} {\vert {Y}_{0 , k} \vert}^{2} - {P}_{s} - {P}_{w}$$
where Nₛ denotes the number of preamble sequences allocated to the serving segment, i.e., the number of subcarriers allocated a preamble sequence, Y_{0,k} denotes a signal received over the k^{th} subcarrier of the serving segment, P_{w} denotes the average noise power, and Pₛ denotes the signal power of the serving segment.

5. The method of claim 1, wherein the interference power of each interference segment is calculated using:
$${I}_{i} = \frac{1}{{N}_{i}} {\sum }_{k = 0}^{{N}_{i} - 1} {\vert {Y}_{i , k} \vert}^{2} - {P}_{w}$$
where Nᵢ denotes the number of preamble sequences allocated to the i^{th} interference segment, i.e., the number of subcarriers allocated a preamble sequence, Y_{i,k} denotes a signal received over the k^{th} subcarrier of the i^{th} interference segment, and P_{w} denotes the average noise power.

6. The method of claim 1, wherein the SINR is calculated using:
$$SINR = \frac{{P}_{s}}{{I}_{0} + {I}_{1} + {I}_{2} + {P}_{w}}$$
where P_{w} denotes the average noise power, Pₛ denotes the signal power of the serving segment, and Iᵢ denotes the interference power of the i^{th} segment.

7. An apparatus for measuring a signal to interference and noise ratio (SINR) in a mobile communication system using preambles, comprising:
an analog-to-digital converter (ADC) for converting a receiving (RX) signal into a time-domain digital signal and outputting the time-domain digital signal to an SINR estimator;
a fast Fourier transform (FFT) processor for transforming a cyclic prefix (CP)-removed time-domain RX signal into a frequency-domain signal and outputting the frequency-domain signal to the SINR estimator; and
the SINR estimator for calculating an average noise power using the time-domain digital signal, calculating a signal power of a serving segment using the RX frequency-domain signal, calculating an average power of the serving segment and an average power of each interference segment using a preamble signal of the RX frequency-domain signal, calculating an interference power of the serving segment and an interference power of the interference segment using the calculated average noise power, the calculated signal power of the serving segment, the calculated average power of the serving segment, and the calculated average power of the interference segment, and estimating an SINR using the calculated average noise power, the calculated signal power and interference power of the serving segment, and the calculated interference power of the interference segment.

8. The apparatus of claim 7, wherein the SINR estimator comprises:
a noise power estimator for calculating the average noise power using a cyclic prefix (CP) of the RX signal and outputting the calculated average noise power to a serving segment signal/interference power estimator, an interference segment interference power estimator, and an SINR calculator;
the serving segment signal/interference power estimator for calculating the signal power of the serving segment using the RX frequency-domain signal on an assumption that a frequency-domain channel is identical between adjacent subcarriers in a same segment, calculating the average power of the serving segment using the RX frequency-domain preamble signal, calculating the interference power of the serving segment using the difference between the calculated average power and the sum of the calculated average noise power and the calculated signal power of the serving segment, and outputting the calculated signal power and interference power of the serving segment to the SINR calculator;
the interference segment interference power estimator for calculating the average power of each interference segment, calculating the interference power of each interference segment using the difference between the calculated average noise power and the calculated average power, and outputting the calculated interference power of each interference segments; and
the SINR calculator for calculating the SINR of the RX signal by dividing the calculated signal power of the serving segment by the sum of the calculated average noise power and the total interference power of all the segments.

9. A method for acquiring an interference power in a mobile communication system, comprising:
calculating an interference power of the serving segment using a plurality of received preamble signals from the serving segment; and
calculating an interference power of each interference segment using a plurality of received preamble signals from the each interference segment.

10. The method of claim 9, wherein the interference power of the serving segment is calculated using:
$${I}_{0} = \frac{1}{{N}_{s}} {\sum }_{k = 0}^{{N}_{s} - 1} {\vert {Y}_{0 , k} \vert}^{2} - {P}_{s} - {P}_{w}$$
where Nₛ denotes the number of preamble sequences allocated to the serving segment, i.e., the number of subcarriers allocated a preamble sequence, Y_{0,k} denotes a signal received over the k^{th} subcarrier of the serving segment, P_{w} denotes the average noise power, and Pₛ denotes the signal power of the serving segment.

11. The method of claim 9, wherein the interference power of each interference segment is calculated using:
$${I}_{i} = \frac{1}{{N}_{i}} {\sum }_{k = 0}^{{N}_{i} - 1} {\vert {Y}_{i , k} \vert}^{2} - {P}_{w}$$
where Nᵢ denotes the number of preamble sequences allocated to the i^{th} interference segment, i.e., the number of subcarriers allocated a preamble sequence, Y_{i,k} denotes a signal received over the k^{th} subcarrier of the i^{th} interference segment, and P_{w} denotes the average noise power.

12. A mobile communication system for acquiring an interference power, comprising:
means for receiving signals from a serving segment and each interference segment; and
means for calculating an interference power of the serving segment using a plurality of preamble signals of the received signals from the serving segment and calculating an interference power of each interference segment using a plurality of preamble signals of the received signals from the each interference segment.

13. The mobile communication system of claim 12, wherein the interference power of the serving segment is calculated using:
$${I}_{0} = \frac{1}{{N}_{s}} {\sum }_{k = 0}^{{N}_{s} - 1} {\vert {Y}_{0 , k} \vert}^{2} - {P}_{s} - {P}_{w}$$
where Nₛ denotes the number of preamble sequences allocated to the serving segment, i.e., the number of subcarriers allocated a preamble sequence, Y_{0,k} denotes a signal received over the k^{th} subcarrier of the serving segment, P_{w} denotes the average noise power, and Pₛ denotes the signal power of the serving segment.

14. The mobile communication system of claim 12, wherein the interference power of each interference segment is calculated using:
$${I}_{i} = \frac{1}{{N}_{i}} {\sum }_{k = 0}^{{N}_{i} - 1} {\vert {Y}_{i , k} \vert}^{2} - {P}_{w}$$
where Nᵢ denotes the number of preamble sequences allocated to the i^{th} interference segment, i.e., the number of subcarriers allocated a preamble sequence, Y_{i,k} denotes a signal received over the k^{th} subcarrier of the i^{th} interference segment, and P_{w} denotes the average noise power.

15. A method for measuring a signal to interference and noise ratio (SINR) in a mobile communication system, comprising:
calculating an average power of the serving segment, and calculating an interference power of the serving segment using the difference between the calculated average power and the sum of the calculated average noise power and the calculated signal power of the serving segment using a plurality of received preamble signals from the serving segment;
calculating an average power of each interference segment, and calculating an interference power of each interference segment using the difference between the calculated average noise power and the calculated average power using a plurality of received preamble signals from the each interference segment; and
calculating an SINR of the RX signal by dividing the calculated signal power of the serving segment by the total interference power of all the segments.

16. The method of claim 15, wherein the interference power of the serving segment is calculated using:
$${I}_{0} = \frac{1}{{N}_{s}} {\sum }_{k = 0}^{{N}_{s} - 1} {\vert {Y}_{0 , k} \vert}^{2} - {P}_{s} - {P}_{w}$$
where Nₛ denotes the number of preamble sequences allocated to the serving segment, i.e., the number of subcarriers allocated a preamble sequence, Y_{0,k} denotes a signal received over the k^{th} subcarrier of the serving segment, P_{w} denotes the average noise power, and Pₛ denotes the signal power of the serving segment.

17. The method of claim 15, wherein the interference power of each interference segment is calculated using:
$${I}_{i} = \frac{1}{{N}_{i}} {\sum }_{k = 0}^{{N}_{i} - 1} {\vert {Y}_{i , k} \vert}^{2} - {P}_{w}$$
where Nᵢ denotes the number of preamble sequences allocated to the i^{th} interference segment, i.e., the number of subcarriers allocated a preamble sequence, Y_{i,k} denotes a signal received over the k^{th} subcarrier of the i^{th} interference segment, and P_{w} denotes the average noise power.

18. An apparatus for measuring a signal to interference and noise ratio (SINR) in a mobile communication system, comprising:
an analog-to-digital converter (ADC) for converting a receiving (RX) signal into a time-domain digital signal;
a Fast Fourier Transform (FFT) processor for transforming a cyclic prefix (CP)-removed time-domain RX signal into a frequency-domain signal; and
a SINR estimator for estimating an SINR using the time-domain digital signal and a plurality of preamble signals of the frequency-domain signal.

19. The apparatus of claim 18, wherein the SINR estimator, in order to estimate the SINR, performs the steps of:
calculating an average noise power using the time-domain digital signal, calculating a signal power of a serving segment using the RX frequency-domain signal, calculating an average power of the serving segment and an average power of each interference segment using a preamble signal of the RX frequency-domain signal, calculating an interference power of the serving segment and an interference power of the interference segment using the calculated average noise power, the calculated signal power of the serving segment, the calculated average power of the serving segment, and the calculated average power of the interference segment, and estimating an SINR using the calculated average noise power, the calculated signal power and interference power of the serving segment, and the calculated interference power of the interference segment.

20. The apparatus of claim 18, wherein the SINR estimator comprises:
a noise power estimator for calculating the average noise power using a cyclic prefix (CP) of the RX signal and outputting the calculated average noise power to a serving segment signal/interference power estimator, an interference segment interference power estimator, and an SINR calculator;
the serving segment signal/interference power estimator for calculating the signal power of the serving segment using the RX frequency-domain signal on an assumption that a frequency-domain channel is identical between adjacent subcarriers in a same segment, calculating the average power of the serving segment using the RX frequency-domain preamble signal, calculating the interference power of the serving segment using the difference between the calculated average power and the sum of the calculated average noise power and the calculated signal power of the serving segment, and outputting the calculated signal power and interference power of the serving segment to the SINR calculator;
the interference segment interference power estimator for calculating the average power of each interference segment, calculating the interference power of each interference segment using the difference between the calculated average noise power and the calculated average power, and outputting the calculated interference power of each interference segments; and
the SINR calculator for calculating the SINR of the RX signal by dividing the calculated signal power of the serving segment by the sum of the calculated average noise power and the total interference power of all the segments.
